(19) United States
(12) Patent Application Publication
(10) Pub. No.: US 2012/0265768 A1
(43) Pub. Date: Oct. 18, 2012

(54) ENCODING AND DECODING METHOD AND APPARATUS FOR MULTIMEDIA SIGNATURES

(75) Inventors: PAUL BRASNETT, Surrey (GB); Miroslaw Bober, Surrey (GB)

(73) Assignee: Mitsubishi Electric Corporation, Tokyo (JP)

(21) Appl. No.: 13/310,443

(22) Filed: Dec. 2, 2011

Related U.S. Application Data
(63) Continuation of application No. 13/123,181, now abandoned.

(30) Foreign Application Priority Data
Oct. 8, 2008 (GB) 0818463.2

(51) Int. Cl. G06F 17/30

(52) U.S. Cl. 707/748; 707/736; 707/752; 707/E17.02; 707/E17.009

(57) ABSTRACT

A method for encoding a descriptor of multimedia content, in which the descriptor includes a plurality of components describing respective parts of the multimedia content comprises processing the descriptor to determine a priority of the plurality of components, and encoding the components of the descriptor based on the determined priority. A method of decoding the descriptor comprises decoding a predetermined number of the plurality of components, by decoding each of the components in the priority order. Advantageously, the encoding and decoding techniques enable fast, scalable searching.

### BACKGROUND

The present invention relates to the processing of signatures that represent multimedia content and, more particularly, to a method and apparatus for encoding and decoding such signatures.

An item of multimedia content can be represented by a “signature” (also known as “robust hash” or “fingerprint”). A signature provides a compact, unique and robust description based on the content. For example, co-pending European patent application number EP 06255239.3, and UK patent application numbers GB 0700468.2, GB 0712388.8, GB 0719833.6 and GB 0800364.2, describe signatures for images, also known as “image descriptors” or “image identifiers”. European patent application EP-A-1 550 297 describes a signature for audio content and US patent application US-A-2007/0253594 describes a signature for video content.

Multimedia signatures typically comprise a plurality of components comprising numbers, often these numbers are in binary space. The signatures can be used for identifying, searching and locating identical or near-duplicate content.

With the vast amount of multimedia data being generated it is clearly a requirement that searches are performed very quickly with low complexity.

### SUMMARY

The present invention relates to methods for encoding and storing signatures, and to corresponding methods for decoding the encoded signatures, to support fast searching.

In accordance with a first aspect, the present invention provides a method for encoding a descriptor of multimedia content, the method comprising: receiving a descriptor of multimedia content, the descriptor including a plurality of components describing respective parts of the multimedia content; processing the received descriptor to determine a priority of the plurality of components, and encoding the components of the descriptor based on the determined priority.

In embodiments, the priority of the plurality of components may be determined using a priority ordering heuristic. For example, the priority of the plurality of components may be determined by considering the entropy of each of the plurality of components or a subset thereof.

In one embodiment, an estimated entropy value is determined for each of the plurality of components in the descriptor, or a subset thereof, using at least one probability distribution of a dataset of corresponding descriptors.

In one embodiment, a priority score for each of the plurality of components in the descriptor, or a subset thereof, is determined, and a priority order for the components is derived by arranging the priority scores and/or associated components in consecutive order.

The method of encoding preferably further comprises encoding the components of the descriptor, or a subset thereof, in the determined priority order.

In one embodiment, after determining a priority order for the components of the descriptor, the method further comprises determining an inter-dependence of each of the plurality of components of the descriptor, or a subset thereof, and updating the determined priority order based on the determined inter-dependence. The step of determining an inter-dependence of each of the plurality of components of the descriptor, or a subset thereof, may comprise considering the correlation of each component with every other component that has a higher priority in the determined priority order.

The method of encoding, according to such an embodiment, preferably further comprises encoding the components of the descriptor, or a subset thereof, in the updated priority order.

In accordance with a second aspect, the present invention provides a method for decoding a descriptor of multimedia content, the method comprising: receiving a plurality of components of an encoded descriptor of multimedia content, the components of the descriptor describing respective parts of the multimedia content, the components received in a priority order that is different from the order of the corresponding components in the unencoded descriptor; and decoding a predetermined number of the plurality of components, by decoding each of said predetermined number of components in the order in which they are received.

Typically, the predetermined number of plurality of components of the descriptor is less than the total number of the plurality of components of the descriptor.

In accordance with the third aspect, the present invention provides a method for image searching, comprising: receiving an encoded descriptor of a query image; decoding the descriptor of the query image using a method according to the second aspect of the present invention; determining a distance, preferably a Hamming distance, between the decoded predetermined number of the plurality of components of the descriptor of the query image and corresponding components of the descriptor of one or more reference images, and selecting reference images for which the determined distance is below a predetermined threshold.

In the embodiments, the method preferably further comprises decoding the remaining components of the descriptor of the query image, and for each of the selected reference images, comparing all of the decoded components of the descriptor of the query image with all of the components of the descriptor of the selected reference image.

In accordance with other aspects, the present invention provides: an encoder for encoding a descriptor of multimedia content, configured to execute a method according to the first aspect of the present invention; a computer readable medium comprising instructions which, when executed by a processor, perform an encoding method according to the first aspect of the present invention; a decoder for decoding a descriptor of multimedia content, configured to execute a method according to the second aspect of the present invention; a computer readable medium comprising instructions which, when executed by a processor, perform a decoding method according to the second aspect of the present invention; an apparatus for performing a method of image searching in accordance with the third aspect of the present invention, and a computer readable medium comprising instructions which, when executed by a processor, perform a method in accordance with the third aspect of the present invention.

In one embodiment, a binary signature, such as the one described in EP 06255239.3, uniquely represents multimedia content. As described in EP 06255239.3 the signature may be represented as a binary string. The signatures may be encoded, stored and/or transmitted as a bitstream or in some other suitable format such as XML. The encoded bitstream (or other data structure) containing the signatures may be received and decoded for use in content searching and matching.

Aspects of the present invention relate to methods for encoding and decoding a bitstream (or other data structure) containing one or more content-based signatures.

A key aspect to the encoding of the signature is a priority ordering of the components of the signature. In one embodiment, a signature comprising a predetermined number of bits is encoded so that the signature bits with the highest priority are placed first in the encoded data structure, such as a bitstream. Preferably, the priority ordering of components, such as the bits, of the signature is based on their entropy. Suitable techniques for ordering the components of a signature in priority order, and the technical advantages arising therefrom, are described below.

Advantageously, the encoding and decoding techniques of the present invention support fast, scalable searching and hashing.

### BRIEF DESCRIPTION OF THE DRAWINGS

FIG. 1 illustrates the probability that a component bit of an exemplary 512 bit image signature is equal to 1, determined using a technique that may be implemented in an embodiment of the present invention;

FIG. 2 illustrates a correlation between bits of the 512 bit image signature of FIG. 1, determined using a technique that may be implemented in an embodiment of the present invention;

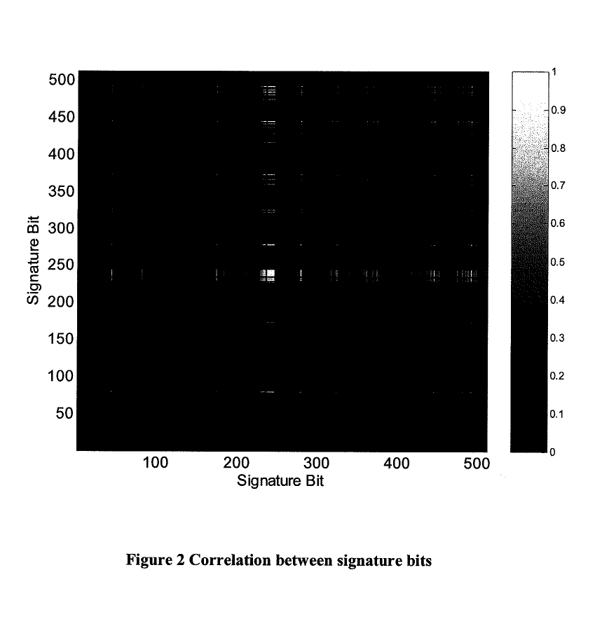

FIG. 3 illustrates the entropy for an exemplary 512 bit signature;

FIG. 4 is a flow diagram illustrating a method for encoding multimedia signatures, in accordance with an embodiment of the present invention, and

FIG. 5 is a schematic diagram of a system for encoding and decoding multimedia signatures, in accordance with embodiments of the present invention.

### DETAILED DESCRIPTION OF THE EMBODIMENTS

The following description is concerned with the encoding and decoding of signatures of images, derived using one or more of the methods mentioned above. It will be appreciated, however, that the encoding and decoding techniques can be used with signatures derived from other types of multimedia content, which may be derived using any suitable technique.

Accordingly, the following description relates to the encoding and decoding of the signature of an image, composed of a binary string.

In particular, a signature S of an image I(x,y) is composed of a set of n-bits with indexes from 0 to n−1:

S(I(x,y))={s₀,s₁, . . . sₙ₋₁}.

In general, each bit (s₀ to sₙ₋₁) in the image signature S will have individual characteristics relating to the expected value, independence and robustness. The characteristics of each bit (sᵢ) can be determined experimentally by evaluating signatures extracted from a set of data (i.e. signatures of a plurality of images). Desirably this experimental data set will be large.

Based on these characteristics the bits in the signature can be evaluated to obtain a priority score for each bit (s₀ to sₙ₋₁) with the highest score being given to the most informative bits. For this purpose, a heuristic can be used to determine the priority order of the bits based on experimental evaluation.

In one preferred embodiment a function ƒ is used to determine the priority score based on the entropy value for each bit:

ƒ(sᵢ)=−p₁(sᵢ)log₂ p₁(sᵢ)−p₀(sᵢ)log₂ p₀(sᵢ),

where p₁(sᵢ) is the probability that sᵢ is 1 p(sᵢ=1) and p₀ (sᵢ)=1−p₁(sᵢ) is the probability that sᵢ is 0. The entropy is in the range 0 to 1, with a higher value means higher entropy, the value reaches a maximum when

p(sᵢ=1)=p(sᵢ=0)=0.5.

The probabilities for the bits of the signature p(sᵢ=1) can be estimated by extracting and evaluating signatures from a large dataset of M images:

$$\hat{p} ( {s}_{i} = 1 ) \approx \frac{1}{M} {\sum }_{m} {s}_{i}$$

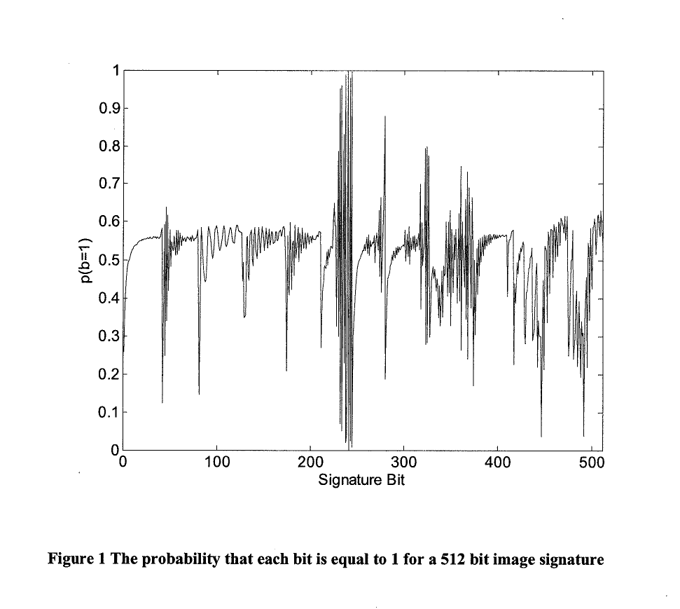

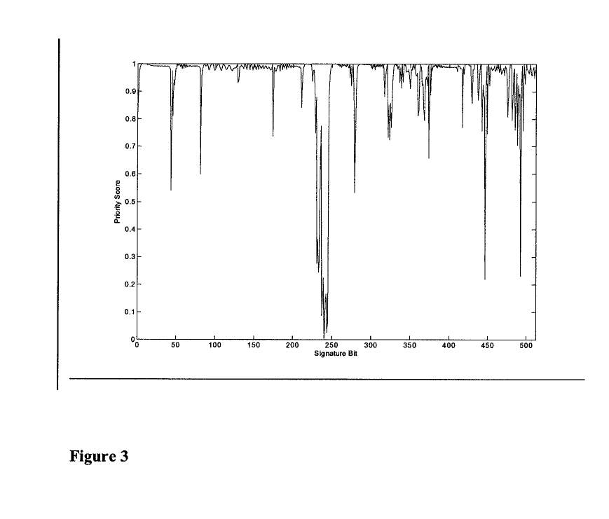

FIG. 1 shows, by way of example, an estimate of the probability p(sᵢ=1) of each bit in a 512 bit image signature, determined experimentally. It will be appreciated that other functions may be used to evaluate the components of a signature to determine their entropy. FIG. 3 shows the corresponding priority scores ƒ(sᵢ) for the same exemplary 512 bit image signature.

The priority scores ƒ(sᵢ) for the signature bits (s₀ to sₙ₋₁) are arranged into descending order, that is the bit with the highest score first, maintaining the indexes of the bits in S:

ƒ(sᵢ)≧ƒ(sⱼ)≧ . . . ≧ƒ(sₖ).

This priority ordering can then be used for the encoding of the bits (s₀ to sₙ₋₁) of image signatures S as described below.

In an alternative embodiment, the inter-bit dependence (e.g. expressed by correlation) can also be considered as part of the priority ordering heuristic. Once an initial ordering has been obtained θ(sᵢ)≧θ(sⱼ)≧ . . . ≧θ(sₖ), for instance in accordance with the embodiment described above, the correlation of every bit with every higher priority bit is considered.

The correlation cε(0,1] can be found experimentally on a set of data, where 0 represents uncorrelated bits and 1 represents correlated bits. The maximum of the correlation with all higher priority bits is then found:

cₘₐₓ(sⱼ),

and a new priority score can be obtained

g(sⱼ)=ƒ(sⱼ)+αcₘₐₓ(sⱼ),

where α is a design parameter to determine the influence of the correlation of the ordering. An updated priority ordering is then obtained

g(sᵢ)≧g(sⱼ)≧ . . . ≧g(sₖ).

Note that the first bit is always the same after this second priority ordering.

Thus, in this alternative embodiment, the updated priority ordering can then be used for the encoding of the bits (s₀ to sₙ₋₁) of image signatures S as described below.

In particular, the indexes of the bits (s₀ to sₙ₋₁) in S are now obtained from the relevant priority ordering:

i,j, . . . , k.

Using these indexes the bits of the signature are encoded into a bitstream (or other structure) in the determined priority ordering:

S̅={sᵢ,sⱼ, . . . , sₖ}.

By way of example, the bitstream syntax that contains three image priority ordered image signatures, derived using the method of GB 0807411.4 is given below.

| ImageSignature { | Number of bits | Mnemonics |
|---|---|---|
| GlobalSignatureA | 512 | bslbf |
| GlobalSignatureB | 512 | bslbf |
| FeaturePointCount | 8 | uimsbf |
| for( k=0; k<NumberOfPoints; k++ ) { | | |
| Xcoord | 8 | uimsbf |
| Ycoord | 8 | uimsbf |
| Direction | 4 | uimsbf |
| LocalSignature | 60 | bslbf |
| } | | |
| } | | |

The XML schema corresponding to the bitstream is given below.

<complexType name=”ImageSignatureType” final=”#all”>

<complexContent>

<extension base=”mpeg7:VisualDType”>

<sequence>

<element name=″GlobalSignatureA″>

<simpleType>

<restriction>

<simpleType>

<list itemType=″mpeg7:unsigned1″ />

</simpleType>
<length value=″512″ />

</restriction>

</simpleType>

</element>

</sequence>

```
  <sequence>
  <element name=″GlobalSignatureB″>
```

<simpleType>

<restriction>

<simpleType>

<list itemType=″mpeg7:unsigned1″ />

</simpleType>
<length value=″512″ />

</restriction>

</simpleType>

</element>
<element name=″LocalSignature″>

<complexType>

<sequence>

<element name=″FeaturePointCount″>

<simpleType>

<restriction base=″nonNegativeInteger″>

<minInclusive value=″32″ />
<maxInclusive value=″80″ />

</restriction>

</simpleType>

</element>
<element name=″FeaturePoint″ minOccurs=″32″

maxOccurs=″80″>

<complexType>

<sequence>

<element name=″XCoord″ type=″mpeg7:unsigned8″/>
<element name=″YCoord″ type=″mpeg7:unsigned8″/>
<element name=″Direction″

type=″mpeg7:unsigned4″/>

<element name=″LocalSignature″>

<simpleType>

<restriction>

<simpleType>

<list itemType=″mpeg7:unsigned1″/>

</simpleType>
<length value=″60″ />

</restriction>

</simpleType>

</element>

</sequence>

</complexType>

</element>

</sequence>

</complexType>

</element>

</seguence>

</extension>

</complexContent>

</complexType>

The bitstream (or other structure) is decoded by reading in the priority ordered signature up to the required number of bits. In particular, a decoding method receives the encoded bitstream (or other data structure) and decodes only the first m bits from the n bit signature in the bitstream, for use in image searching and matching. Since the priority ordered signatures in the encoded bitstream store the most informative bits first, the decoding technique decodes the most relevant bits first, thereby enabling fast searching and matching because only the m most relevant bits are used when comparing two signatures. In addition, the decoding technique provides a scalable signature. The following advantages arise from such a system.

First, it is possible to find the distance (e.g. Hamming distance) between two signatures, this is a coarse level distance that would be less robust and/or independent than the distance calculated on the full n-bits. The complexity of the distance calculation is linearly related to the number of bits so using fewer bits m provides lower computational requirements.

Secondly, it is possible to create a hash table, based on the m-bits, of the signature's structure for rapidly reducing the search space to k-nearest neighbours. In a preferred embodiment m is 8, giving a 256 element hash table and k is 1 therefore the search space is reduced to approximately 8/256 of the original size.

Finally, it is possible to reduce search times by eliminating low probability matches. If a search is to be carried out to find all signatures with a normalised distance below a threshold T₁ from a query signature then in a preferred embodiment the first m bits are compared and only if the normalised distance is below T₂ are all n bits extracted and compared. If the normalised distance is above T₂ then the two signatures are declared different. In the preferred embodiment T₂=T₁+ε, where ε≧0. In such a searching method, images that are declared to be similar, based upon the comparison of the first m-bits and/or all n bits, may be provided as search results (for example by displaying the corresponding images on a display screen)

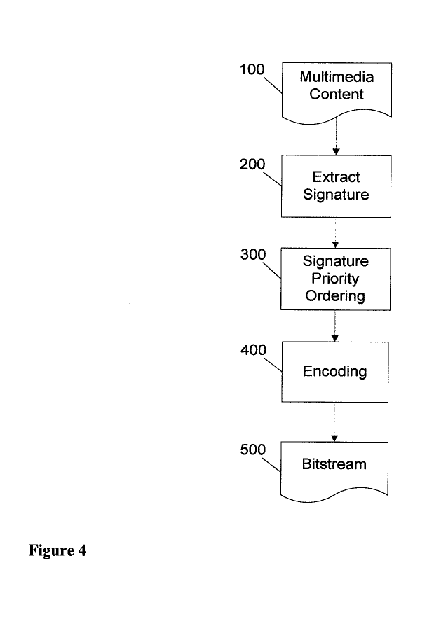

FIG. 4 is a flow diagram showing a method for encoding multimedia signatures according to an embodiment of the present invention.

The method starts at step 100, which receives the multimedia content to be encoded.

At step 200, for each part of the multi-media content that is to be encoded separately (e.g. each image), a predefined content-based signature is extracted. As described above, the signature comprises a predetermined number of signature components such as a number of binary bits. Any suitable technique for extracting such a signature from the received multimedia content may be used. For example, if the multimedia content comprises still images, a signature to each image may be derived by processing the image using one or more of the techniques described in the aforementioned patent applications EP 06255239.3, GB 0700468.2, GB 0712388.8, GB 0719833.6 and GB 0800364.2

At step 300, a priority ordering is derived for at least some of the components of the predefined signature. The priority ordering may be determined using one of the above-described techniques of the embodiments, or any other suitable technique.

At step 400, each signature is encoded according to the priority ordering determined in step 300.

Finally, at step 500, the encoded signatures are provided as a bitstream (or other data structure) which may be transmitted or stored for use by a decoder. The data structure may be transmitted or stored in binary or XML format, as discussed above, or any other suitable format.

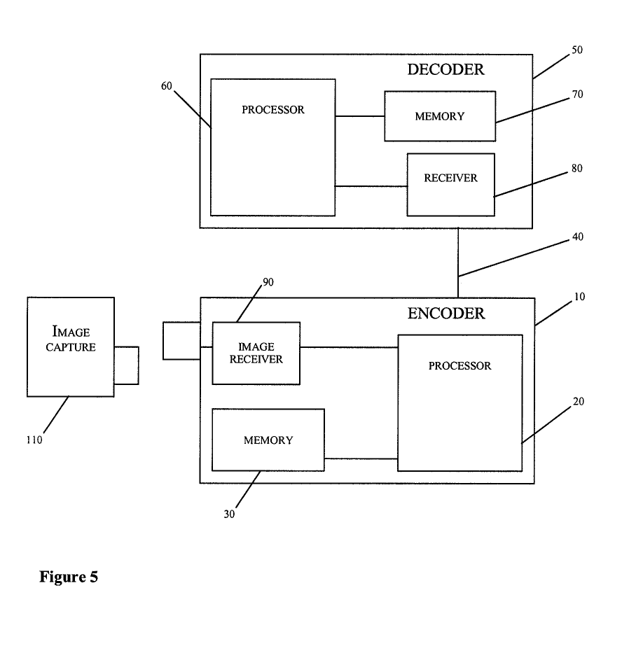

The above-described method of encoding may be performed in an encoding apparatus 10 comprising a processor 20, as illustrated in FIG. 5. Typically, the method is implemented in the form of a computer program comprising instructions, executable by the processor 20, to perform the above described method steps.

A corresponding decoding method may be performed in a decoding apparatus 50 comprising a processor 60, as illustrated in FIG. 5. Typically, the decoding method is implemented in the form of a computer program comprising instructions, executable by the processor 60. The decoding method comprises receiving and decoding the first m components (e.g. bits) of each encoded signature in the received data structure (e.g. bitstream), which can then be used for image searching and matching, as described above.

Referring in detail to FIG. 5, an encoder 10 receives images at an image receiver module 90 from an image capture device, such as a camera 110. Encoder processor 20 processes the images, and encodes signatures corresponding to the images, in accordance with the above described techniques. Optionally, encoder processor 20 stores the encoded image signatures, and corresponding images, in memory 30.

Encoder processor 20 may further transmit the encoded image signatures (e.g. as an encoded bitstream), and optionally the corresponding images, over a communication link 40 to a receiver 80 of decoder 50. Decoder processor 60 decodes the received image signatures, in accordance with the above described techniques. Optionally, decoder processor 60 stores the decoded image signatures, and corresponding images, in memory 70. Decoder processor may further perform image searching and matching using decoded image signatures stored in memory 70, in accordance with the above described techniques.

### Alternative Implementations

In alternative embodiments, a signature may be comprised of non-binary data components. This may also be arranged by priority order and encoded into a bitstream or other data structure.

The described embodiments order all of the bits in a signature by their priority. As the skilled person will appreciate, it may not be necessary or desirable to order all bits in such a way. Thus, alternative embodiments include a partially priority ordered encoding, where the highest m-bits are encoded based on priority ordering and then the remaining bits in their original order.

A priority order may be formed from any type of signature extracted from any type of multimedia content, including still and moving images, audio content etc

As the skilled person will appreciate, many variations and modifications may be made to the described embodiments. It is intended to include all such variations, modifications and equivalents which fall within the spirit and scope of the present invention.

1. A method for encoding a descriptor of multimedia content, the method comprising:
receiving a descriptor of multimedia content, the descriptor including a plurality of components describing respective parts of the multimedia content;
processing the received descriptor to determine a priority of the plurality of components, and
encoding the components of the descriptor based on the determined priority.

2. A method as claimed in claim 1, wherein the priority of the plurality of components is determined using a priority ordering heuristic.

3. A method as claimed in claim 1 or claim 2, wherein the priority of the plurality of components is determined by considering the entropy of each of the plurality of components or a subset thereof.

4. A method as claimed in claim 1, wherein considering the entropy of each of the plurality of components, or a subset thereof, comprises determining an entropy value for each said component.

5. A method as claimed in claim 1, further comprising determining an estimated entropy value for each of the plurality of components in the descriptor, or a subset thereof, using at least one probability distribution of a dataset of corresponding descriptors.

6. A method as claimed in claim 1, comprising determining a priority score for each of the plurality of components in the descriptor, or a subset thereof, and deriving a priority order for the components by arranging the priority scores and/or associated components in consecutive order.

7. A method as claimed in claim 6, comprising encoding the components of the descriptor, or a subset thereof, in the determined priority order.

8. A method as claimed in claim 1, further comprising determining an inter-dependence of each of the plurality of components of the descriptor, or a subset thereof, and updating the determined priority order based on the determined inter-dependence.

9. A method as claimed in claim 8, wherein determining an inter-dependence of each of the plurality of components of the descriptor, or a subset thereof, comprises considering the correlation of each component with every other component that has a higher priority in the determined priority order.

10. A method as claimed in claim 8 or claim 9, comprising encoding the components of the descriptor, or a subset thereof, in the updated priority order.

11. A method as claimed in claim 1, wherein the descriptor is a binary signature, and each component comprises one or more bits of the binary signature.

12. A method as claimed in claim 1, further comprising transmitting or storing the encoded descriptor in a predefined format.

13. An encoder for encoding a descriptor of multimedia content, configured to execute a method as claimed in claim 1.

14. A computer readable medium comprising instructions which, when executed by a processor, perform an encoding method as claimed in claim 1.

15. A method for decoding a descriptor of multimedia content, the method comprising:
receiving a plurality of components of an encoded descriptor of multimedia content, the components of the descriptor describing respective parts of the multimedia content, the components received in a priority order that is different from the order of the corresponding components in the unencoded descriptor; and
decoding a predetermined number of the plurality of components, by decoding each of said predetermined number of components in the order in which they are received.

16. A method as claimed in claim 15, wherein the predetermined number of plurality of components of the descriptor is less than the total number of the plurality of components of the descriptor.

17. A decoder for decoding a descriptor of multimedia content, configured to execute a method as claimed in claim 15 or claim 16.

18. A computer readable medium comprising instructions which, when executed by a processor, perform a decoding method as claimed in claim 15 or claim 16.

19. A method for image searching, comprising:
receiving an encoded descriptor of a query image;
decoding the descriptor of the query image using a method as claimed in claim 15 or claim 16;
determining a distance, preferably a Hamming distance, between the decoded predetermined number of the plurality of components of the descriptor of the query image and corresponding components of the descriptor of one or more reference images, and
selecting reference images for which the determined distance is below a predetermined threshold.

20. A method as claimed in claim 19, further comprising:
decoding the remaining components of the descriptor of the query image, and
for each of the selected reference images, comparing all of the decoded components of the descriptor of the query image with all of the components of the descriptor of the selected reference image.

21. Apparatus for performing a method of image searching
as claimed in claim 19.

22. A computer readable medium comprising instructions which, when executed by a processor, perform a method as claimed in claim 19.
